(19) United States
(12) Patent Application Publication
(10) Pub. No.: US 2013/0035915 A1
(43) Pub. Date: Feb. 7, 2013

(54) SYSTEM AND METHOD FOR MULTIPLE TARGET TRACKING

(71) Applicant: ATS GROUP (IP HOLDINGS) LIMITED, Tortola (VG)

(72) Inventor: Amichai Painsky, Ra'anana (IL)

(73) Assignee: ATS GROUP (IP HOLDINGS) LIMITED, Tortola (VG)

(21) Appl. No.: 13/651,090

(22) Filed: Oct. 12, 2012

Related U.S. Application Data
(63) Continuation of application No. PCT/US2011/032799, filed on Apr. 15, 2011.
(60) Provisional application No. 61/324,648, filed on Apr. 15, 2010.

(51) Int. Cl. G06F 17/10

(52) U.S. Cl. 703/2

(57) ABSTRACT

Embodiments of the present invention generally relate to systems and methods comprising First Order Multiple Hypothesis Testing for a Global Nearest Neighbor Data Correlation solution. Generating and storing multiple target hypotheses to allow immediate recovery in case of a false decision in uncertain association environment, improves the system's ability to handle multiple target tracking, in terms of tracker error, and creates a more accurate situational picture for a system's operator. Introducing the quality factor, and a configurable number of maximum hypotheses testing, assures the system is easily adjustable to different environments, to balance tradeoffs between its estimation accuracy and computational load.

### CROSS REFERENCE TO RELATED APPLICATIONS

This application is a continuation of International Patent Application No. PCT/US2011/032799, filed on Apr. 15, 2011, entitled “SYSTEM AND METHOD FOR MULTIPLE TARGET TRACKING”, which itself claims priority to U.S. Provisional Patent Application Ser. No. 61/324,646, filed Apr. 15, 2010, both of which are incorporated by reference herein in their entirety.

### BACKGROUND

1. Field

The following generally relates to apparatuses, methods and various elements, portions and/or embodiments thereof directed to multiple targets tracking (“MTT”) in various environments. The following further relates to apparatuses, methods and various elements, portions and/or embodiments thereof directed to carrying out MTT in and/or with, for example, surveillance systems, where such MTT is carried out in accordance with an MTT engine that is robustly adaptable to various environments, including any of a well-spread, moderately-dense, dense and like-type environment in which the multiple targets may be slow, moderate, fast and like-type maneuvering targets.

2. Related Art

The growing necessity for multiple targets tracking (“MTT”) functionality and associated architecture (“MTT engine”) for use in and/or with surveillance systems, in combination with recent and dramatic increases in computational capabilities, has lead to a swell of interest in and proffering of various suggested solutions for improving performance of classical data correlation methods, such as the Global Nearest Neighbor (“GNN”) method, for handling and solving for enhanced schemes of data correlation. The generally accepted and preferred data correlation method for MTT is the Multiple Hypothesis Testing (“MHT”) method, as the MHT method has proven to achieve better results over other classical data correlations methods with respect to complicated and uncertain environments.

Due to its complexity, however, replacing a GNN engine with an MHT engine in a deployed system requires extensive modifications to, e.g., software, firmware, hardware, etc. of, such system, and introduces a significant engineering cost and risk to any and all environments (collectively “target-tracking environments”) the deployed system handles following the replacement of the GNN engine. Moreover, if the surveillance system, and in turn, the GNN engine is deployed at different sites that address a plurality of target-tracking environments of different complexities, the extensive modifications necessary to replace the GNN engine with a MHT engine may be too costly and even superfluous.

Therefore, there is a need for apparatuses, methods and various elements, portions and/or embodiments thereof directed to carrying out MTT in and/or with, for example, surveillance systems, where such MTT is carried out in accordance with an MTT engine that is robustly adaptable to various environments, including any of a well-spread, moderately-dense, dense and like-type environment in which the multiple targets may be slow, moderate, fast and like-type maneuvering targets. There is a further need for such apparatuses, methods and various elements, portions and/or embodiments thereof to be deployable at different sites and/or address a plurality of target-tracking environments, of which may include target-tracking environments of different complexities.

### BRIEF DESCRIPTION OF THE DRAWINGS

So the manner in which above recited features of the present invention can be understood in detail, a more particular description of embodiments of the present invention, briefly summarized above, may be had by reference to embodiments, several of which are illustrated in the appended drawings.

Figures in the appended drawings, like the detailed description, are examples. As such, the Figures and the detailed description are not to be considered limiting, and other equally effective examples are possible and likely. Furthermore, like reference numerals in the Figures indicate like elements, and wherein:

FIG. 1 is a block diagram illustrating an example of a surveillance system adapted to perform multiple targets tracking (“MTT”);

FIG. 2 is a block diagram illustrating an example of an MTT engine adapted to perform MTT;

FIG. 3 is a flow diagram illustrating an example flow for performing MTT;

FIG. 4 is a work flow diagram illustrating an example work flow for performing MTT during a first iteration of an MTT engine after an initialization of the MTT engine;

FIGS. 5A-B are work flow diagrams illustrating an example work flow for performing MTT during a second iteration of an MTT engine following an initialization of the MTT engine;

FIGS. 6A-B are work flow diagrams illustrating an example work flow for performing MTT during third and subsequent iterations of an MTT engine following an initialization of the MTT engine;

FIG. 7 is work flow diagrams illustrating an example work flow for performing MTT during third and subsequent iterations of an MTT engine following an initialization of the MTT engine;

FIG. 8 is a graph illustrating improvement of MTT correlations carried out in accordance with a First Order Multiple Hypothesis Testing (“First-order MHT”) method over MTT correlations carried out in accordance with the classical Global Nearest Neighbor (“GNN”) method;

FIG. 9 is a graph illustrating improvement of MTT correlations carried out in accordance with the First-order MHT method over MTT correlations carried out in accordance with the classical GNN method; and

FIG. 10 is a graph illustrating improvement of MTT correlations carried out in accordance with the First-order MHT method over MTT correlations carried out in accordance with the classical GNN method.

### DETAILED DESCRIPTION

In the following detailed description, numerous specific details are set forth in order to provide a thorough understanding of embodiments or other examples described herein. In some instances, well-known methods, procedures, components and circuits have not been described in detail, so as to not obscure the following description.

Further, the examples disclosed are for exemplary purposes only and other examples may be employed in lieu of, or in combination with, the examples disclosed. It should also be noted the examples presented herein should not be construed as limiting of the scope of embodiments of the present disclosure, as other equally effective examples are possible and likely.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

Overview

Provided herein are examples of apparatuses, methods and various elements, portions and/or embodiments thereof directed to multiple targets tracking (“MTT”) in various environments. Also provided herein are examples of apparatuses, methods and various elements, portions and/or embodiments thereof directed to carrying out MTT in and/or with, for example, surveillance systems, where such MTT is carried out in accordance with an MTT engine that is robustly adaptable to various target-tracking environments. Examples of such various target-tracking environments may include any of a well-spread environment, a moderately dense environment, a dense environment, an ambiguous environment, an unambiguous environment and the like.

In any of the various target-tracking environments, any target of the multiple targets disposed therein may maneuver at any of number of various velocities for any given period of time. Any target of the multiple targets may be, for example, a slow maneuvering target or a fast maneuvering target. With respect to the former, such target is a slow maneuvering target when it maneuvers at a velocity that satisfies (e.g., is below and/or equal to) a threshold set to a velocity for classifying targets as slow maneuvering targets (“slow-velocity threshold”). With respect to the latter, the target is a fast maneuvering target when it maneuvers at a velocity that satisfies (e.g., is above and/or equal to) a threshold set to a velocity for classifying targets as fast maneuvering targets (“fast-velocity threshold”).

In some instances, the fast-velocity and slow-velocity thresholds may be set to the same velocity. Alternatively, the fast-velocity threshold may be greater than the slow-velocity threshold. In such case, any target of the multiple targets maneuvering at a velocity falling between the fast-velocity and slow-velocity thresholds may be classified as a moderate maneuvering target. Each of the fast-velocity and slow-velocity thresholds may be predetermined and/or configurable, and may be modified, adjusted and/or otherwise changed on the fly or at any other time.

Embodiments of the present invention generally relate to a cost-effective, robust method for MTT in different environments through a First Order MHT method for a Global Nearest Neighbor (“GNN”) engine.

Generating and storing multiple target hypotheses allows a substantially immediate recovery in cases of a false decision in uncertain association environments. In addition, it improves the system's ability to handle MTT, and creates a more accurate situational picture for the system's operator. Introducing a quality factor, and a configurable number of maximum hypotheses testing, assures the system can be easily adjusted to different environments to balance tradeoffs between its estimation accuracy and computational load.

In an embodiment of the present invention, the system and method comprise a First-order MHT method for a GNN data correlation solution. Generating and storing multiple target hypotheses to allow immediate recovery in case of a false decision in uncertain association environment, improves the system's ability to handle MTT, in terms of MSE, and creates a more accurate Situational Picture for the system's operator.

In an embodiment of the present invention, there is provided a system and method comprising a quality factor, and a configurable number of maximum hypotheses, which assures the system is easily adjustable to different environments, to balance tradeoffs between its estimation accuracy and computational load.

In an embodiment of the present invention, there is provided a method of generating and storing a configurable number of best (better) associations for a GNN based data correlation method, at each iteration, and displaying the one that achieves the best association value, given a new set of incoming observations. This method further comprises a configurable quality factor, which defines a relative value of the best association below which an association will not be considered as possible hypothesis and will not be stored.

Example Architecture

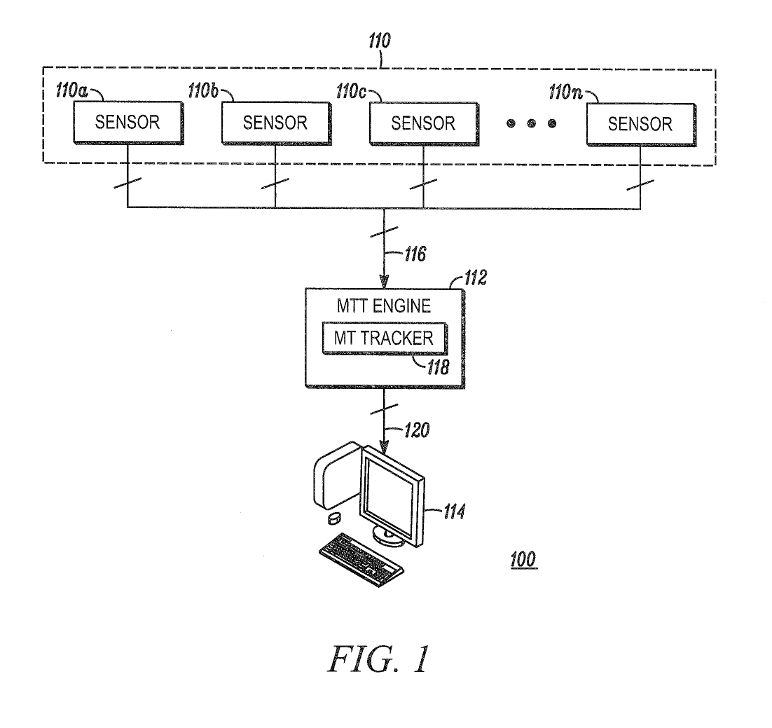

FIG. 1 is a block diagram illustrating an example of a surveillance system 100 adapted to carry out MTT. The surveillance system 100 may include a one or more, or a network of, sensors (collectively “sensors”) 110; an MTT engine 112; and a device having a display (“display device”) 114 operable to display one or more sets of states (e.g., positions, velocities, etc.) of the multiple targets being tracked.

The sensors 110 may include a first sensor 110a, a second sensor 110b, a third sensor 110c and an nth-sensor 110n. Each of the sensors 110 may be any of an electrical, optical or other type of sensor that has an associated detection region, and that may acquire, capture or otherwise obtain one or more sets of observations of targets (“observation sets”) appearing in its detection region. Each of the observation sets may include, for example, location, velocity and the uncertainty of these measures (covariance matrix).

The sensors 110 may communicatively couple to the MTT system 112 via respective communication links 116, and provide respective observation sets to the MTT 112, via such links 116. The sensors 110 may be operable to provide their respective observation sets, for example, continuously, at various discrete times and/or in response to any of a query, poll, request and the like (collectively “request”) received from the MTT system 112.

The MTT engine 112 may receive or otherwise obtain (collectively “obtain”) the observation sets from the sensors 110 at various times. The MTT engine 112 may include a multiple target tracker (“MT tracker”) 118. The MT tracker 118 may be operable to carry out the MTT, as a function of the observation sets, and to determine, for any of the various times, from a number, N, sets of states of the multiple targets (“multiple-target hypotheses”), a multiple-target hypothesis that best correlates to the observation sets for such time. To facilitate this, the MT tracker 118 may be configured in accordance with novel correlation methods and/or functionality thereof described herein, including the First-order MHT method described in detail below.

The MTT engine 112 may be further operable to provide the best multiple-target hypothesis to the display device 114 via communication link 120. The display device 114 may be adapted to obtain the best multiple-target hypothesis from the MTT system 112, and to display the best multiple-target hypothesis to a user of the surveillance system 100. To facilitate this, the display device 114 may be any device capable displaying the best multiple-target hypothesis (in one form or another) to the user.

The display device 114 may be, for example, any of a personal computer; a portable computer, a handheld computer; a mobile phone, a digital assistant, a personal digital assistant, a cellular phone, a smart phone, a pager, a digital tablet, a laptop computer, an Internet appliance and the like. The display device 114 may include a large number of elements; most of which are not shown in FIG. 1 for simplicity of exposition. In general, however, the display device 114 includes a computational platform that is adapted to operate on any suitable operating system, such as Microsoft® Windows®, Android, Linux and/or Symbian; and that is capable of executing software. The processing platform may be operable to control, manipulate or otherwise interact with a monitor or other display device (collectively “display”) and/or an input/output (“I/O”) device, via respective couplings.

The display may be any suitable device that displays viewable images generated by the processing platform. For instance, the display may be any of a liquid-crystal-display based monitor, a cathode ray tube monitor, a plasma display monitor, a surface-conduction electron-emitter display monitor, an organic light-emitting diode display monitor, or any other monitor that can display viewable images using television and/or computer protocols, such as Super Video Graphics Array, Digital Visual Interface, Phase Alternating Line, SECAM, NTSC, etc.

The I/O device may be any device that accepts input from a user (man or machine) to control, manipulate or otherwise interact with the operation of the processing platform. Examples of the I/O device include any of a pointing device, such as a mouse, joystick, trackball, touchpad, pointing stick, light pen, head pointer, soap mouse, eye tracking devices, digitizing tablet and stylus, data glove that translates the user's movements to computer gestures; and a key-in device, such as a keyboard or a touchpad.

Each of the communication links 116, 120 may be formed from one or more linkable segments. These segments may be disposed in one or more wired and/or wireless communication networks and/or one or more electrical busses.

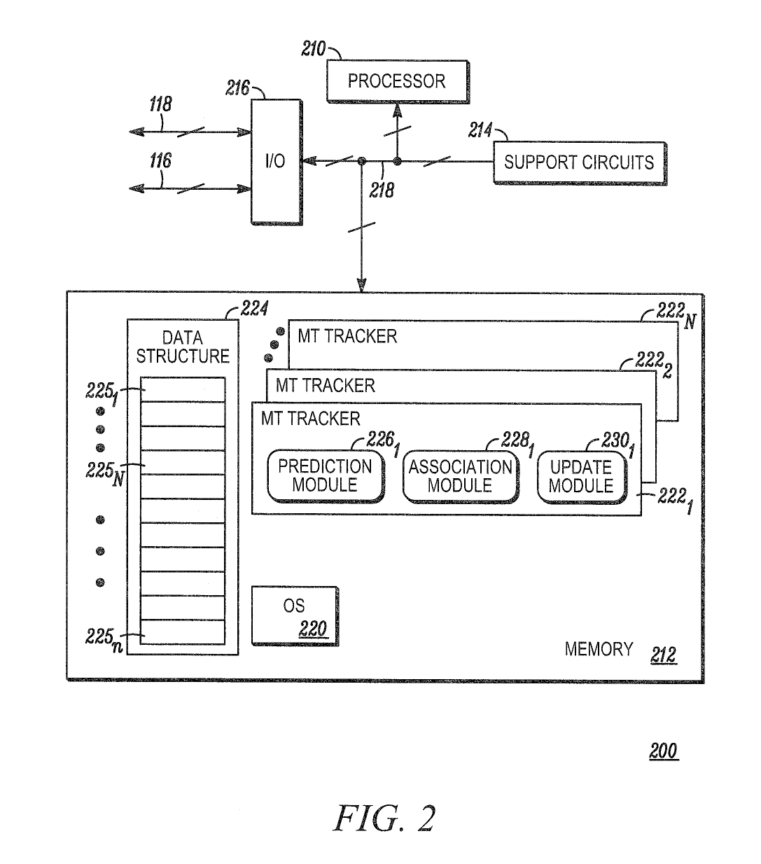

Referring now to FIG. 2, a block diagram illustrating an example of an MTT engine 200 adapted to perform MTT. The MTT engine 200 of FIG. 2 is similar to the MTT engine 112 of FIG. 1, except as described herein.

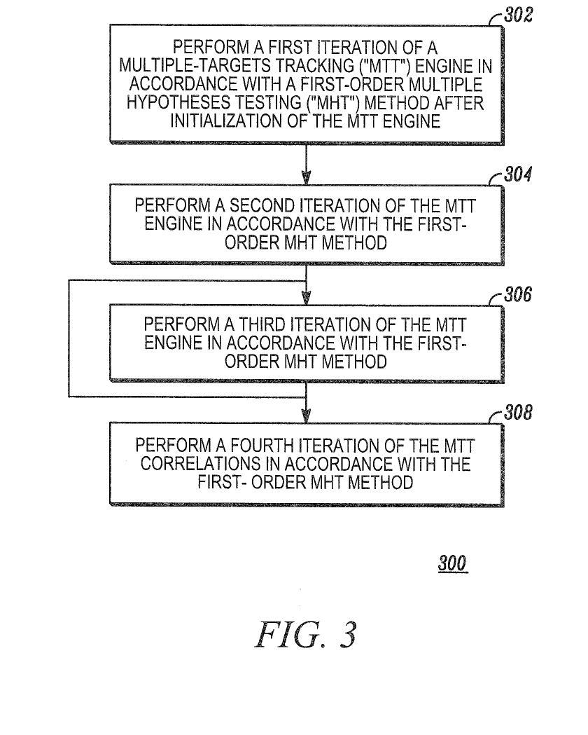

The MTT engine 200 may include one or more servers, and may be deployed in one or more general or specialty purpose computers, personal computers, mainframes, minicomputers, server-type computers and/or any a processor-based platform that operates on any suitable operating system, such as Microsoft® Windows® and/or Linux; and that is capable of executing software. The MTT engine 200 may include a large number of elements; many of which are not shown in FIG. 3 for simplicity of exposition. The elements of MTT engine 200 may be formed in a single unitary device and concentrated on a single server, client, peer or other type node. Alternatively, the elements of the MTT engine 200 may be formed from two or more separate devices, and as such, may be distributed among a number of server, client, peer or other type nodes.

As shown, the MTT engine 200 includes one or more computational units (collectively “processor”) 210, memory 212, supports circuits 214, I/O interface 216 and one or more buses and/or communication links 218. The processor 212 may be one or more conventional processors, microprocessors, multi-core processors, microcontrollers and the like. The bus 218 provides for transmissions of information among the processor 210, memory 212, support circuits 214, I/O interface 216 and other portions of the MTT system 200 (not shown). The support circuits 214 facilitate operation of the processor 210, and may include well-known circuitry or circuits, including, for example, one or more I/O interfaces; one or more NIUs; cache; clock circuits; power supplies and the like.

The I/O interface 216 provides an interface to control the transmissions of information between components of MTT system 200 (shown and not shown). In addition, the I/O interface 216 provides an interface to control the transmissions of information between and/or among devices associated with or otherwise attached to the MTT system 200, including, for example, the sensors 110 (FIG. 1).

The memory 212 may store and be queried by the processor 210 to obtain various software packages, such as operating system 220 and MT trackers 222_{1-N}. The memory 212 may be or employ random access memory, read-only memory, optical storage, magnetic storage, removable storage, erasable programmable read only memory and variations thereof, content addressable memory and variations thereof, flash memory, disk drive storage, removable storage, any combination thereof, and the like.

In addition, the memory 212 may include a data store 224. The data store 224 may include a number, n, of records (“data-store records”) 225₁₋ₙ, where n may be at least equal to the square of the number of MT trackers 222_{1-N}. The data-store records 225₁₋ₙ may be adapted to store various information generated by the MT trackers 222_{1-N} during operation.

The memory 212 may also store operands, operators, dimensional values, configurations, and other data that may be used by the MT trackers 222_{1-N} and the operating system 220 to control the operation of and/or facilitate performing the functions of the MTT engine 200.

The MTT engine 200 may be deployed in accordance with the scale-up and/or scale-out approaches. Using the scale-up approach, the MTT engine 200 may increase its processing power, amount of memory and number of networkable connections by utilizing a symmetrical, multi-processor architecture so as to provide additional capacity. A benefit of this scale-up approach is that such approach provides for simplified configuration and management as compared to the scale-out approach. Using the scale-out approach, the MTT engine 200 may increase its processing power, amount of memory and number of networkable connections by incrementally adding and/or removing capacity as needed, balancing workload across multiple processors, multiple servers, dedicating specific processors and/or servers for performing specific tasks, using physical or logical servers (e.g., a multi-node cluster approach), etc.

The operating system 220 may include and/or be embodied in various software and/or executable instructions or code for operating the MTT system 200. The operating system 220, when executed by the processor 210, provides a platform on which the MT trackers 222_{1-N} can be executed. Each MT tracker 222, when executed by the processor 210, is operable to perform MTT, as a function of the observation sets, and to determine, for the various times, the N multiple-target hypotheses and the best multiple-target hypothesis. Like the MT tracker 118 of FIG. 1, each MT tracker 222 may be configured in accordance with the novel correlation methods and/or functionality thereof described herein, including the First-order MHT method described in detail below. For simplicity of exposition and because each of the MT trackers 222_{1-N} have the same or similar architecture and functionality, details of only one of the MT trackers 222_{1-N} (referred to herein as “MT tracker 222”) are described below.

To facilitate carrying out the MTT, the MT tracker 222 may be configured with a filter or other signal processing algorithm, such as a Kalman filter prediction and update phase equations, for instance. Alternatively, the MT tracker 222 may be configured as any other device that is operable to generate and output the N multiple-target hypotheses for a given time, k; where such device may generate each multiple-target hypothesis by undertaking measures for minimizing error, for example mean square error (“MSE”), and by converging to a non-linear solution.

The MT tracker 222 may include a prediction module 226, an association module 228 and an update module 230. The prediction, association and update modules 226, 228 and 230 may include respective inputs and outputs. Each of the prediction, association and update modules 226, 228 and 230 may also include one or more programmable and/or hard-coded, executable instructions, commands, directions, code and/or control data (collectively, “directives”) for controlling operation of and/or facilitating performance of functions of such modules 226, 228 and 230.

The prediction module 226 may be operable to predict a set of MT states for a given time, k (“set of predicted-MT states”). The prediction module 226 may be formed, for example, in accordance with a prediction stage of a filter, and be operable to compute, calculate, form or otherwise generate (collectively “generate”) the set of predicted-MT states by converging to an estimate of MT states as a function of a set of MT states for a time prior to the given time, k, such as time, k-1. The prediction module 226 may be further operable to send or otherwise communicate (collectively “communicate”) the set of predicted-MT states to the association module 228.

The association module 228 may be operable to obtain the set of predicted-MT states from the prediction module 226, and to obtain the observation sets for the given time, k, (“incoming observations”) provided to the MTT engine 200 from the sensors 110. The association module 228 may be further operable to generate a configurable number, N, of associations (“targets-to-observations associations”) as a function of the set of predicted-MT states and the incoming observations. The N targets-to-observations associations may include a best targets-to-observations association and N-1 next best targets-to-observations associations. To generate the best targets-to-observations association, the association module 228 may be operable to apply the GNN method or equivalent functionality to the set of predicted-MT states and incoming observations. To generate the N-1 next best targets-to-observation associations, the association module 228 may instead apply one or more versions of the GNN method or equivalent functionality that are modified to cause generation of such associations.

The association module 228 may be further operable to apply a quality factor to the N targets-to-observations associations. The quality factor is a threshold that defines a relative value (e.g., a percentage) of the best targets-to-observations association. The association module 228 may be operable to remove or exempt from the N-1 next best targets-to-observations associations any of such associations that fail to satisfy (e.g., fall below) the best targets-to-observation association multiplied by the quality factor. The association module 228 may also decrement the number, N, by one for each of the N-1 next best targets-to-observations associations that fail to satisfy (e.g., fall below) the quality factor.

Application of the quality factor may prevent the MT tracker 222 from overworking in non-ambiguous environments, in which the incoming observations are well-spread and easily associated, and potentially lead to the association module 228 generating only the best targets-to-observations association, which in turn, may achieve significantly better results. By setting the quality factor to a high enough value (e.g., close to 1), the MT tracker 222 and the larger MTT system 200 may be operable to only generate the N targets-to-observations associations in ambiguous environments, and conversely converge to the best targets-to-observations association under the GNN method or equivalent functionality in unambiguous, e.g., spread and easily analyzed, environments.

The association module 228 may be further operable to perform gating. The association module 228 may carry out such gating, if at all, prior to generating the N targets-to-observation associations. Gating generally reduces the computational load by removing or exempting from candidate generating the N target-to-observations associations those candidate associations that should not be in consideration. The association module 228 may carry out gating in a number of ways. For example, the association module 228 may (I) determine differences in distances between each of the predicted-MT states and the incoming observations, (ii) compare each of the determined differences against a threshold defining a minimum distance (“minimum-distance threshold”) above which any predicted-MT states and incoming observations should not be considered as a candidate association, and for each of the determined differences satisfying the minimum-difference threshold, (iii) adding the corresponding incoming observations to the predicted-MT state's list of candidates for generating the N target-to-observations associations

The association module 228 may be further operable to communicate the N targets-to-observation associations to the update module 230. The update module 230 may be operable to obtain the N targets-to-observation associations. The update module 230 may also be operable to generate N multiple-target hypotheses (i.e., N sets of updated MT states) for the given time, k; one for each of the N targets-to-observation associations. To facilitate generating the N multiple-target hypotheses, the update module 230 may be formed, for example, in accordance with a update stage of a filter, and be operable to generate, for each of the N targets-to-observation associations, one of the N multiple-target hypotheses by converging to an estimate of MT states as a function of such targets-to-observation association. The N multiple-target hypotheses may include a best multiple-target hypothesis and N-1 next best multiple-target hypotheses corresponding to the best targets-to-observations association and N-1 next best targets-to-observations associations, respectively. The update module 230 may be further operable to communicate the N multiple-target hypotheses to the data store 224.

The data store 224 may be operable to obtain the N multiple-target hypotheses communicated from the update module 230, and to store them in data-store records 225_{1-N}. The data-store record 225₁ may store the best multiple-target hypothesis, and if N is greater than 2, the data-store records 225_{2-N} may store the N-1 next best multiple-target hypotheses in, for example, descending order based on a measure of quality. Alternatively, the data-store records 225_{1-N} may store the N multiple-target hypotheses in no particular order.

The memory 212 may be further operable to receive from the processor 210 a query for the best multiple-target hypothesis, to, responsively, extract the best multiple-target hypothesis from the appropriate data-store record 225, and to communicate such multiple-target hypothesis to the bus 218. The processor 210 may query the memory 212 for the best multiple-target hypothesis, and in connection with the support circuits 214, may direct the best multiple-target hypothesis to the I/O interface 216 for communication to the communication link 120 for termination to the display device 114 (FIG. 1).

Example Operation

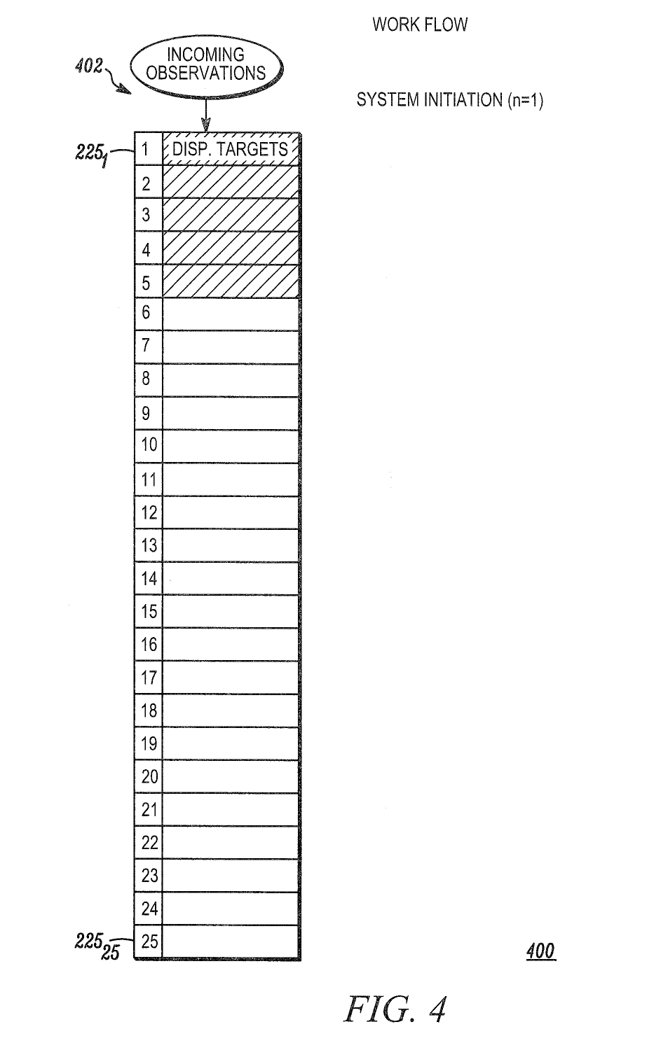

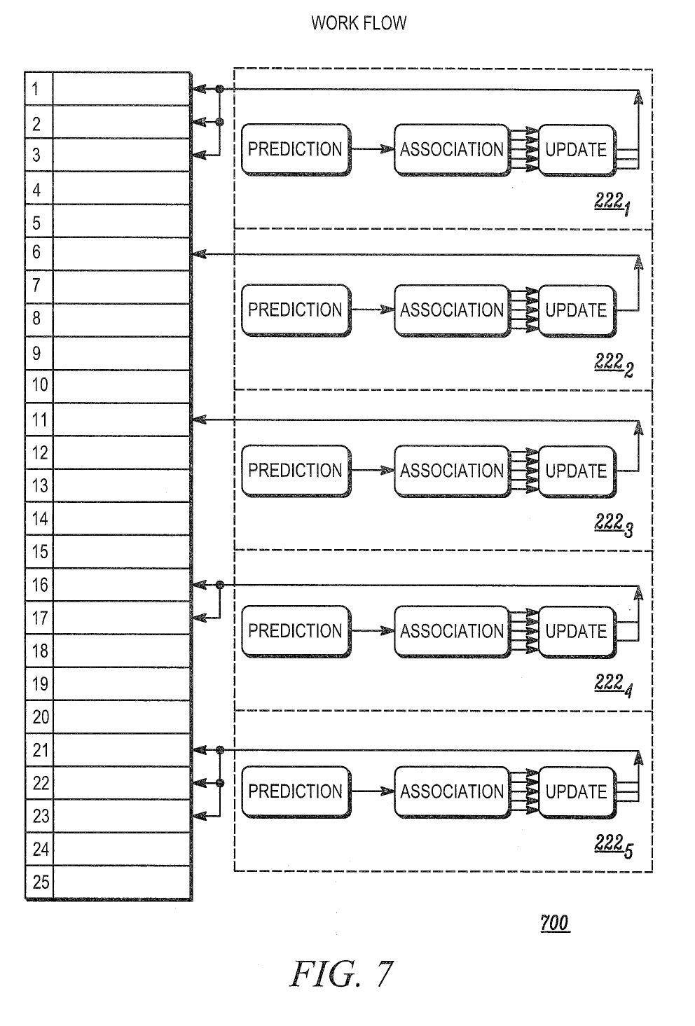

FIG. 3 is a flow diagram illustrating an example flow 300 for performing MTT. The example flow 300 may include first, second, third and fourth processes for performing MTT at various phases of operation of a surveillance system adapted to perform MTT, as shown in blocks 302, 304, 306 and 308. FIGS. 4-7 are work flow diagrams illustrating example work flows 400-700 for performing the first, second, third and fourth processes (shown in blocks 302, 304, 306 and 308), respectively. For convenience, the flow 300 and the work flows 400-700 are described herein with respect to the MTT system 200 and the surveillance system 100 and of FIGS. 2 and 1, respectively. The flow 300 and the work flows 400-700 may be carried out by other systems, as well.

As shown in block 302, a first iteration of the MTT engine 200 is performed after the surveillance system 100 initializes the MTT engine 200. As part of the first iteration, the MTT engine 200 may obtain from the sensors 100, via the I/O interface 216, a first observation set for a time, k. The processor 212 in connection with the support circuits 214, in turn, may direct the I/O interface 216 to communicate the first observation set to the bus 218 for termination to the memory 212.

The memory 212 may obtain the first observation set from the bus 218, and may store it in the data-store record 225₁, as indicated by workflow reference 402. In this example, the data-store record 225₁ may be designated as an appropriate location for storing the set of MT states for termination to the display device 114, which, due to the MTT engine 200 being initialized, such set of MT states is the first observation set.

At some time after the first observation set is stored in the data-store record 225₁, the processor 210 may query the memory 212 for the set of MT states for display, namely, the first observation set stored in the data-store record 225₁. The memory 212, in response to the query, may extract the first observation set from the data-store record 225₁ and to communicate it to the bus 218. The processor 210 in connection with the support circuits 214, may direct the first observation set to the I/O interface 216 for communication to the communication link 120 for termination to the display device 114. The display device 114, after receipt of the first observation set, may display such observation set for viewing by the user of the surveillance system 110.

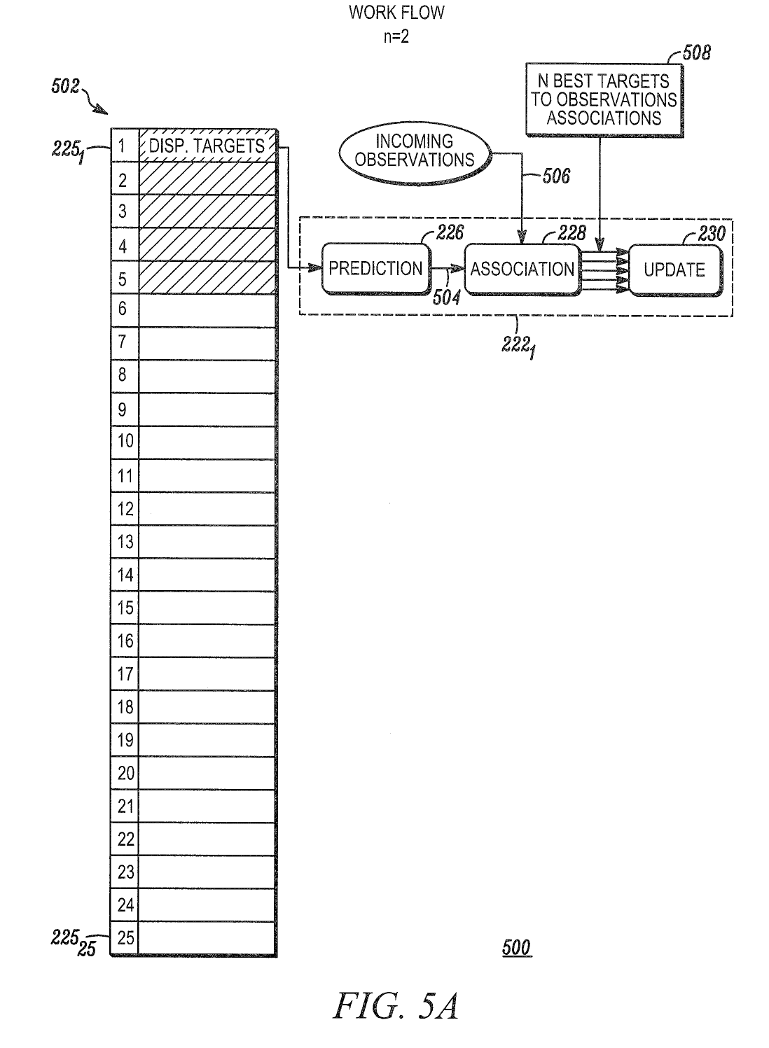

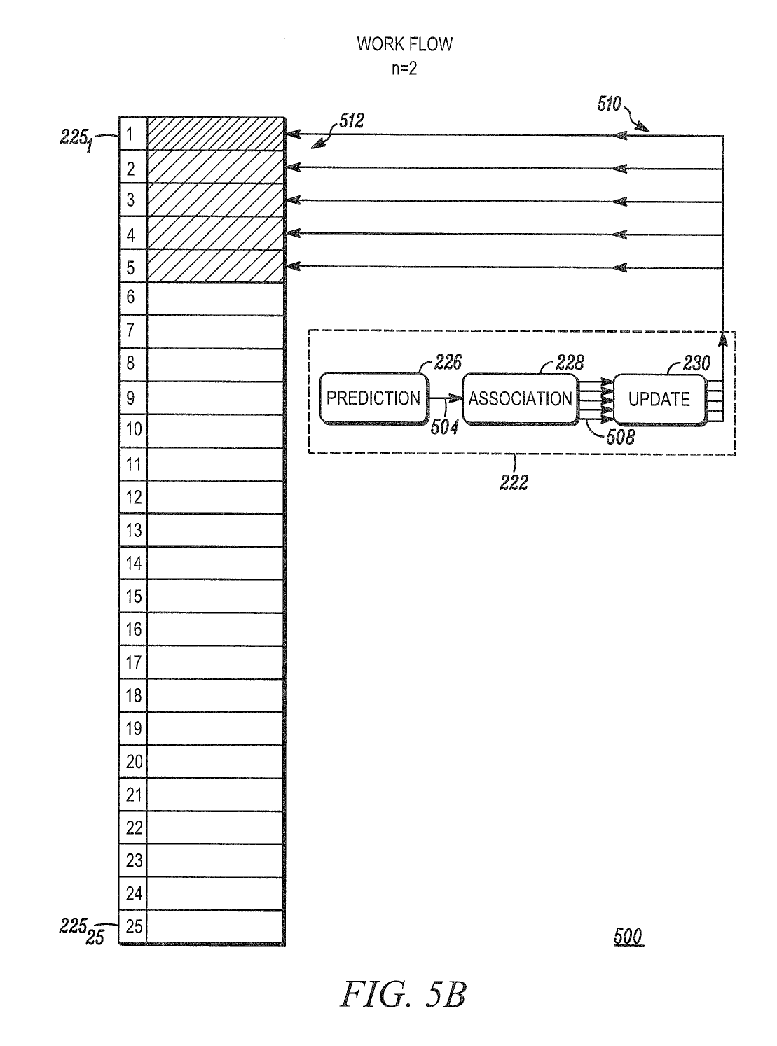

Following the first iteration, a second iteration of the MTT engine may be carried out in accordance with the first-order MHT method, as shown in block 304. As part of the second iteration, the MT tracker 222₁ may request and responsively obtain from the memory 212 the first observation set extracted from the data-store record 225₁, and in turn, may communicate the first observation set to prediction module 226₁, as indicated by workflow reference 502 (FIG. 5A). The prediction module 226₁ may thereafter predict a first set of predicted-MT states for a second time, k+1. The prediction module 226 may, for example, generate the first set of predicted-MT states by converging to an estimate of MT states as a function of a the first observation set. The prediction module 226₁ may then communicate the first set of predicted-MT states to the association module 228₁, as indicated by workflow reference 504.

The association module 228₁ may obtain the first set of predicted-MT states from the prediction module 226₁, as also indicated by workflow reference 504. The association module 228₁ may also obtain a second observation set for the second time, k+1, where such second observation set is provided from the sensors 110 to the association module 228₁ via the I/O interface 216 and the correlator 222₁, as indicated by workflow reference 506. The association module 228₁ may thereafter generate, as a function of the first set of predicted-MT states and the second observation set, the configurable number, N, targets-to-observations associations, where, as shown, N=5, as indicated by workflow reference 508.

For example, the association module 228₁ may apply the GNN method or equivalent functionality to the first set of predicted-MT states and the second observation set to generate the first and best targets-to-observations association. The association module 228₁ may further apply a first modified version of the GNN method or equivalent functionality to the first set of predicted-MT states and the second observation set to generate the second and second best targets-to-observations association. The association module 228₁ may also apply second, third and fourth modified versions of the GNN method or equivalent functionality to the first set of predicted-MT states and the second observation set to generate the third, fourth and fifth best targets-to-observations association, respectively.

Although not shown, the association module 228₁ may have performed gating prior making any associations. In performance of such gating, the association module 228₁ may have first determined the differences in distances between a first of the first set of predicted-MT states and each of the second observations set. Thereafter, the association module 228₁ may have compared each of such determined differences against the minimum-distance threshold. And for each of the determined differences satisfying the minimum-difference threshold, the association module 228₁ may have added the corresponding second observations set to the first predicted-MT state's list of candidates for generating the first through fifth target-to-observations associations.

After generation of the first through fifth target-to-observations associations, the association module 228₁ may communicate such targets-to-observation associations to the update module 230₁, as also indicated by workflow reference 508. The update module 230₁ may, in turn, obtain the first through fifth target-to-observations associations from the association module 228₁.

The update module 230₁ may then generate N (i.e., first through fifth) multiple-target hypotheses for the second time, k+1; one for each of the first through fifth target-to-observations associations. The update module 230₁ may generate the first multiple-target hypothesis, for example, by converging to an estimate of MT states as a function of the first or best targets-to-observations association. The update module 230 may generate the second multiple-target hypothesis by converging to an estimates of MT states as a function of the second best targets-to-observations association. The update module 230 may generate the third through fifth sets of multiple-target hypotheses in the same or similar way as it generated the first and second multiple-target hypotheses. The update module 230 may, however, generate any of the first through fifth multiple-target hypotheses as a function of any one of the first though fifth targets-to-observations associations so long as the first though fifth targets-to-observations associations are only used once. After generating the first through fifth s multiple-target hypotheses, the update module 230 may communicate such multiple-target hypotheses to the bus 218 for termination to the memory 212, as indicated by workflow reference 510 (FIG. 5B).

The memory 212 may obtain first through fifth multiple-target hypotheses from the bus 218, and thereafter store them in the data-store records 225₁₋₅, respectively, as indicated by workflow reference 512. This way, the best multiple-target hypothesis is stored in the data-store record 225₁, which in this example, is designated as the appropriate location for storing the set of MT states for termination to the display device 114.

At some time after the first and/or some or all of the second through fifth multiple-target hypotheses are stored in the data-store records 225₁₋₅, the processor 210 may query the memory 212 for the set of MT states for display, namely, the first multiple-target hypothesis stored in the data-store record 225₁. The memory 212, in response to the request, may extract the first multiple-target hypothesis from the data-store record 225₁, and communicate it to the bus 218. The processor 210 in connection with the support circuits 214, may direct the first multiple-target hypothesis to the I/O interface 216 for communication to the communication link 118, and in turn, for termination to the display device 114. The display device 114, after receipt of the first multiple-target hypothesis, may display such first multiple-target hypothesis for viewing by the user of the surveillance system.

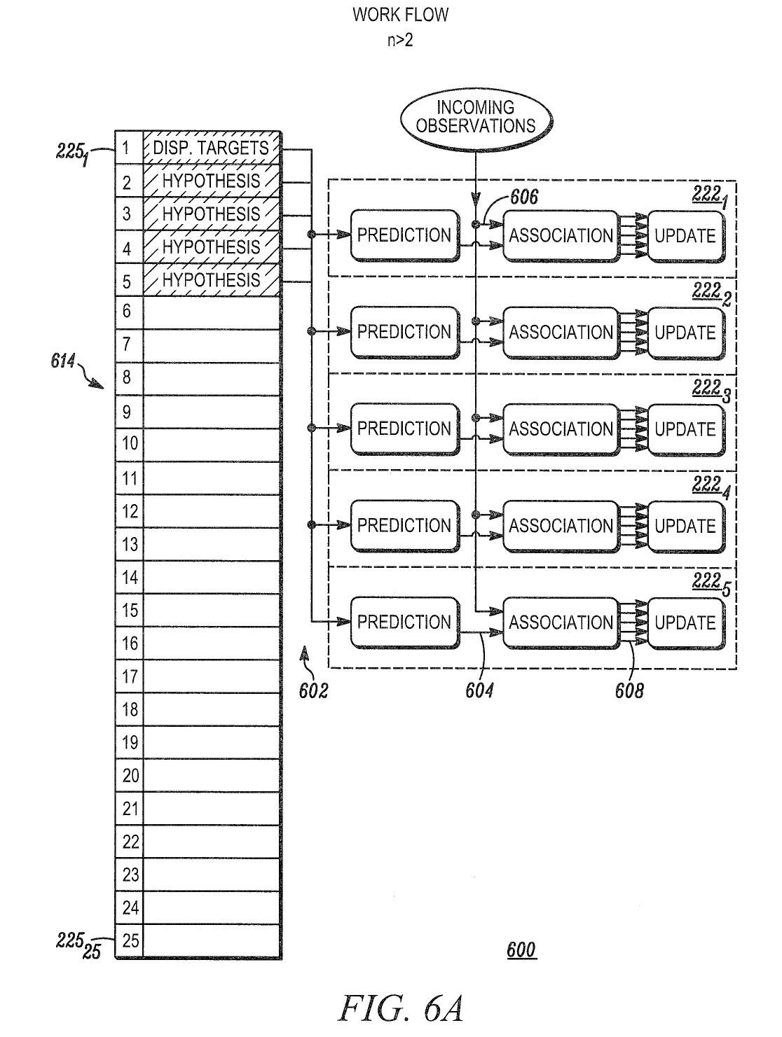

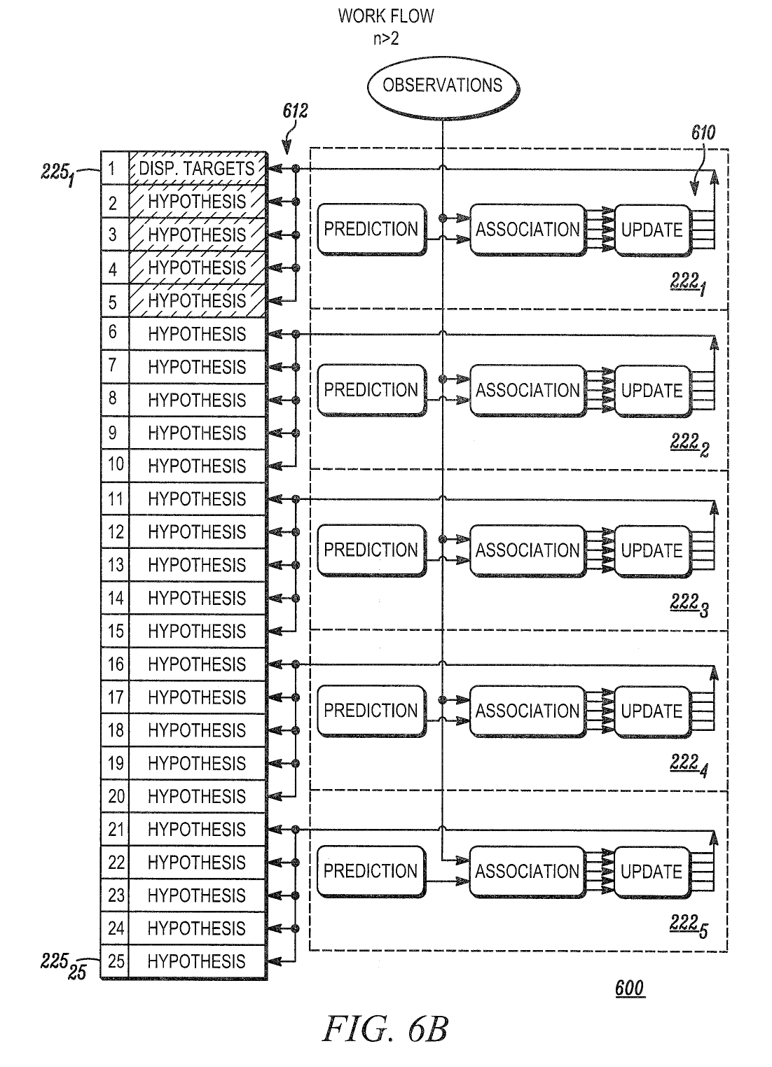

After the second iteration of the MTT engine 200, a third iteration of the MTT engine 200 may be performed in accordance with the First-order MHT method, as shown in block 306. At initiation of the third iteration, the MT trackers 222₁₋₅ may request and responsively obtain from the memory 212 the first through fifth multiple-target hypotheses extracted from the data-store records 225₁₋₅. The MT trackers 222₁₋₅ may, in turn, communicate the first through fifth sets of updated MTT states to prediction modules 226₁₋₅, respectively, as indicated by workflow reference 602 (FIG. 6A). The prediction modules 226₁₋₅ may thereafter predict respective set of predicted-MT states for a third time, k+2, by converging to an estimate of MT states as a function of the respective multiple-target hypotheses. The prediction modules 226₁₋₅ may then communicate the respective sets of predicted-MT states to the association modules 228₁₋₅, as indicated by workflow reference 604.

The association modules 228₁₋₅ may obtain the sets of predicted-MT states from the prediction modules 226₁₋₅, as also indicated by workflow reference 604. The association modules 228₁₋₅ may also obtain a third observation set for the third time, k+2, where such third observation set is provided from the sensors 110 to the association modules 228₁₋₅ via the I/O interface 216 and the correlators 222₁₋₅, as indicated by workflow reference 606. Each of the association modules 228₁₋₅ may thereafter generate, as a function of the corresponding set of predicted-MT states and the third observation set, the configurable number, N, targets-to-observations associations, where, as shown, N=5, as indicated by workflow reference 608.

Each of the association modules 228₁₋₅ may apply the GNN method or equivalent functionality to its corresponding set of predicted-MT states and the third observation set to generate the its best targets-to-observations association. And each of the association modules 228₁₋₅ may further apply a first modified version of the GNN method or equivalent functionality to its corresponding set of predicted-MT states and the third observation set to generate the its second best targets-to-observations association. Each of the association modules 228₁₋₅ may also apply second, third and fourth modified versions of the GNN method or equivalent functionality to its corresponding set of predicted-MT states and the third observation set to generate its third, fourth and fifth best targets-to-observations association, respectively.

Although not shown, each of the association module 228 may have performed gating prior to generating its first through fifth targets-to-observation associations in the same or similar manner as described above.

The association modules 228₁₋₅ may communicate such targets-to-observation associations to the respective update modules 230₁₋₅, as also indicated by workflow reference 608. The update modules 230₁₋₅ may, in turn, obtain the target-to-observations associations from the association modules 228₁₋₅.

Each of the update modules 230₁₋₅ may then generate N (i.e., first through fifth) multiple-target hypotheses for the third time, k+2; one for each of the first through fifth target-to-observations associations. Each of the update modules 230₁₋₅ may generate its first multiple-target hypothesis, for example, by converging to an estimate of MT states as a function of the first or best targets-to-observations association. Each of the update modules 230₁₋₅ may generate its second multiple-target hypothesis states by converging to an estimates of MT states as a function of its second best targets-to-observations association. Each of the update modules 230₁₋₅ may generate its third through fifth multiple-target hypothesis in the same or similar way as it generated its first and second multiple-target hypotheses. Each of the update modules 230₁₋₅ may, however, generate any of the first through fifth multiple-target hypotheses as a function of any one of the first though fifth targets-to-observations associations so long as the first though fifth targets-to-observations associations are only used once. After generating the first through fifth multiple-target hypotheses, each of the update modules 230₁₋₅ may communicate such multiple-target hypotheses to the bus 218 for termination to the memory 212, as indicated by workflow reference 610 (FIG. 6B).

The memory 212 may obtain the five sets of first through fifth multiple-target hypotheses from the bus 218, and thereafter store the (i) first set of first through fifth multiple-target hypotheses in the data-store records 225₁₋₅, respectively; (ii) second set of first through fifth multiple-target hypotheses in the data-store records 225₆₋₁₀, respectively; (iii) third set of first through fifth multiple-target hypotheses in the data-store records 225₁₁₋₁₅, respectively; (iv) fourth set of first through fifth multiple-target hypotheses in the data-store records 225₁₆₋₂₀, respectively; and (v) fifth set of first through fifth multiple-target hypotheses in the data-store records 225₂₁₋₂₅, respectively, as indicated by workflow reference 612.

After the twenty-five multiple-target hypotheses are stored in the data-store records 225₁₋₂₅, the processor 210 sorts the twenty-five multiple-target hypotheses, for example, in descending order as a function the sum of distances between the observations and their associated targets. After sorting the twenty-five multiple-target hypotheses, the best multiple-target hypothesis is stored in the data-store record 225₁, which in this example, is designated as the appropriate location for storing the set of MT states for termination to the display device 114.

At some time after sorting, the processor 210 may query the memory 212 for the set of MT states for display, namely, the first multiple-target hypothesis stored in the data-store record 225₁. The memory 212, in response to the request, may extract the first multiple-target hypothesis from the data-store record 225₁, and communicate it to the bus 218. The processor 210 in connection with the support circuits 214, may direct the first multiple-target hypothesis to the I/O interface 216 for communication to the communication link 120, and in turn, for termination to the display device 114. The display device 114, after receipt of the first multiple-target hypothesis, may display such first multiple-target hypothesis for viewing by the user of the surveillance system.

In addition, the processor 210 may instruct the memory 212 to delete all but the N multiple-target hypotheses. To facilitate this, the memory 212 may clear or otherwise delete all of the data-store records 225₆₋₂₅. Alternatively, all of the multiple-target hypotheses may be maintained in the data-store records 225₁₋₂₅, and the correlators 222₁₋₅ may overwrite the data-store records 225₁₋₂₅ in one or more subsequent iterations.

After the third iteration, the process shown in block 302 may be repeated periodically, in continuous fashion, or upon being triggered as a result of a condition, such as reception additional observation sets.

Alternatively, a fourth iteration of the MTT engine 200 may be carried out in accordance with the First-order MHT method, as shown in block 308. The fourth iteration is the same as the second iteration except that prior to providing their targets-to-observations associations to update modules 230₁₋₅, each of the association modules 228₁₋₅ may apply a quality factor to its first through fifth targets-to-observations associations. As shown in resultant fashion, applying the quality factor results in each of the association modules 228₁₋₅ removing or exempting from its N-1 next best targets-to-observations associations any of such associations that fail to satisfy the quality factor. Each of the association modules 228₁₋₅ may also decrement the number, N, by one for each of the N-1 next best targets-to-observations associations that fail to satisfy the quality factor.

One advantage of embodiments of the present invention is noted by the simulations performed, which demonstrated significant improvement over the classical GNN method in more ambiguous scenarios, such as dense and cluttered environments or fast maneuvering targets.

Furthermore, implementing the First-order MHT method does not necessitate an extensive software architecture change, is easily adjustable to meet different performance requirements, and does not entail sophisticated and complex pruning mechanisms as other MHT-based methods. All these qualities make the upgrade from the classical GNN to an enhanced performance engine less complicated, in terms of code change and risk mitigation, for real-time deployed Command and Control surveillance systems.

Embodiments described herein tackle the sub-optimality of the association phase by taking into consideration a number of feasible associations and choosing one that achieves the best association results, given a set of incoming observations. The possibility of false association is addressed by allowing an immediate recovery followed by corrected continuous tracking

Simulations and Performances

To verify performance of the MTT correlations carried out in accordance with the First-order MHT method and to quantify behavior of such MTT correlations in different environments, targets in different environments were randomly generated and observed through real deployed sensors models. The observations were injected to an MTT system representative of the MTT system 200. The estimated sets of MT states output from the correlator were compared with corresponding simulated sets of MT states. In all simulations the sensors models generated observations according to constant covariance measures, providing a set of observations every two seconds. The area of experiment is 0.5 square kilometer.

Simulation no. 1: Increasing Velocities

Quality Factor −0.7

Number of simulated targets—20

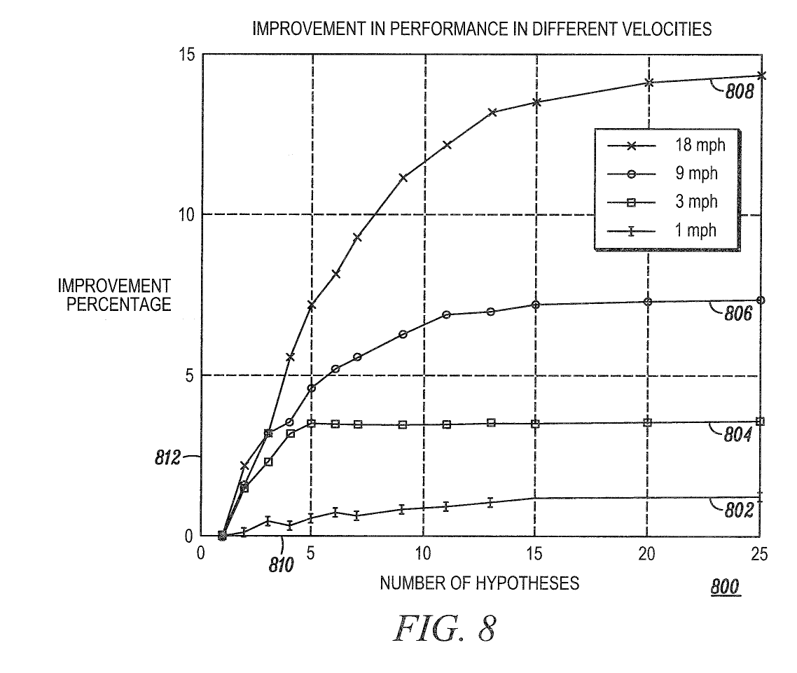

FIG. 8 is a graph 800 illustrating improvement of MTT correlations carried out in accordance with the First-order MHT method over MTT correlations carried out in accordance with the classical GNN method. The graph 800 includes curves 802-808, and X and Y axes 810, 812.

The curve 802 depicts a relative improvement in the MSE between simulated and estimated sets of MT states, where the velocities of targets are approximately 1 mile per hour (“mph”). The curve 804 depicts a relative improvement in the MSE between simulated and estimated sets of MT states, where the velocities of targets are approximately 3 mph. The curve 806 depicts a relative improvement in the MSE between simulated and estimated sets of MT states, where the velocities of targets are approximately 9 mph. And the curve 808 depicts a relative improvement in the MSE between simulated and estimated sets of MT states, where the velocities of targets are approximately 18 mph.

The X 810 describes the maximal number of hypotheses. The Y axis 812 describes the percentile improvement in the MSE as compared to the classical GNN method.

The relative improvement increases, on average, as more sets of updated MT states are allowed to be made for a given environment. This happens up to a saturation level above, which increasing the number of sets of updated MT states does not result with a significant improvement. The reason is that for a given environment, carrying out the First-order MHT method tends to converge to the preferred target tracking (in the described sense) for a certain number of sets of updated MT states. Increasing this value will not show an increase in the relative improvement since the optimum was already achieved.

Moreover, the relative improvement in the MSE becomes more significant as the velocity of the simulated targets increases. The greater velocity makes the tracking of the simulated targets more complicated, which results with more uncertainty in the association phase. Therefore, in higher velocities, the hypotheses' testing demonstrates greater improvement in the performance of the system.

Simulation no. 2: Increasing Number of Targets

Quality Factor −0.7

Targets average velocity—9 mph.

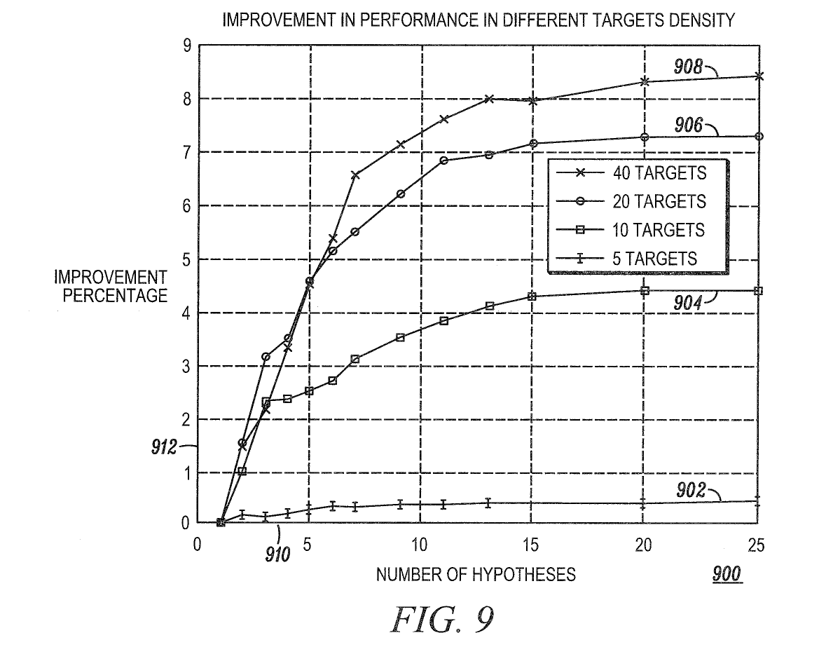

FIG. 9 is a graph 900 illustrating improvement of MTT correlations carried out in accordance with the First-order MHT method over MTT correlations carried out in accordance with the classical GNN method. The graph 900 includes curves 902-908, and X and Y axes 910, 912.

The curve 902 depicts a relative improvement in the MSE between simulated and estimated sets of MT states for five targets in the environment. The curve 904 depicts a relative improvement in the MSE between simulated and estimated sets of MT states for ten targets in the environment. The curve 906 depicts a relative improvement in the MSE between simulated and estimated sets of MT states for twenty targets in the environment. And the curve 908 depicts a relative improvement in the MSE between simulated and estimated sets of MT states for five targets in the environment.

The X axis 910 describes the maximal number of hypotheses. The Y axis 912 describes the percentile improvement in the MSE as compared to the classical GNN method.

In this simulation, the effect of the targets density on the performance of the algorithm is graphed. Increasing the number of targets at a given area results in a more ambiguous association making, which is reflected in greater and closer association results. Therefore, allowing more hypotheses increase the performance in higher density environments.

Simulation no. 3—Decreasing Quality Factors

Number of targets—20

Targets average velocity—9 mph

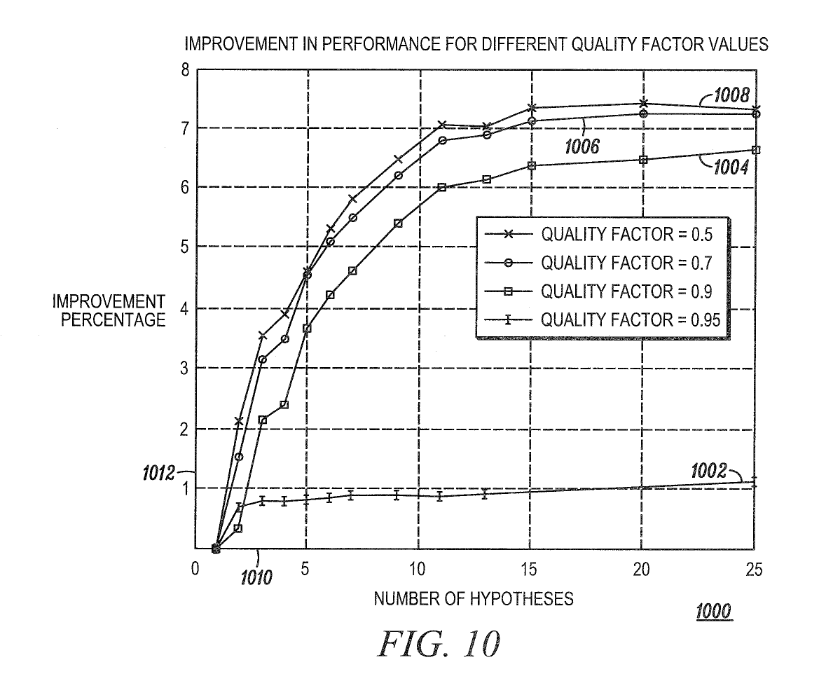

FIG. 10 is a graph 1000 illustrating improvement of MTT correlations carried out in accordance with the First-order MHT method over MTT correlations carried out in accordance with the classical GNN method. The graph 1000 includes curves 1002-1008, and X and Y axes 1010, 1012.

The curve 1002 depicts a relative improvement in the MSE between simulated and estimated sets of MT for a quality factor of 0.95. The curve 1004 depicts a relative improvement in the MSE between simulated and estimated sets of MT states for a quality factor of 0.9. The curve 1006 depicts a relative improvement in the MSE between simulated and estimated sets of MT states for a quality factor of 0.7. And the curve 1008 depicts a relative improvement in the MSE between simulated and estimated sets of MT states for a quality factor of 0.95.

The X axis 1010 describes the maximal number of hypotheses. The Y axis 1012 describes the percentile improvement in the MSE as compared to the classical GNN method.

Here, in an uncertain environment, decreasing the quality factor improve the performance of the system, to a certain point above which it saturates. The reason for this behavior is that decreasing the quality factor allows more, but less valuable, hypotheses testing. These hypotheses may improve the performance only in very ambiguous situation, in which the environment was so hard to track that a very unlikely association ended up being the better one to choose.

### CONCLUSION

Variations of the method, apparatus and system described above are possible without departing from the scope of the invention. In view of the wide variety of embodiments that can be applied, it should be understood that the illustrated embodiments are exemplary only, and should not be taken as limiting the scope of the following claims. For instance, in the exemplary embodiments described herein include handheld devices, which may include or be utilized with any appropriate voltage source, such as a battery and the like, providing any appropriate voltage.

In addition, any communication networks in which the communication links 116, 120 are deployed may be a partial or full deployment of most any communication or computer network, and thus, can include a few or many network elements, most of which are not shown. Each of the communication networks may include circuit-switched as well as packet-data elements to provide transport of the multimedia content and/or adapted-multimedia content, and can be public or private, terrestrial wireless or satellite, and/or wire line. Each of the networks may include portions of a Public Switch Telephone Network (PSTN), the Internet, core and proprietary public networks, wireless voice and packet-data networks, such as 1G, 2G, 2.5G and 3G telecommunication networks, wireless office telephone systems (“WOTS”) and/or wireless local area networks (WLANs), including, Bluetooth and/or IEEE 802.11 WLANs, and the like.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the described methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It should be understood that the exemplary embodiments are not limited to the above-mentioned memories and that other platforms and memories may support the described methods.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Further, as used herein, the term “set” is intended to include any number of items, including zero. Further, as used herein, the term “number” is intended to include any number, including zero.

Moreover, the claims should not be read as limited to the described order or elements unless stated to that effect. In addition, use of the term “means” in any claim is intended to invoke 35 U.S.C. §112, ¶6, and any claim without the word “means” is not so intended.

What is claimed is:

1. A method for tracking multiple targets, the method comprising:
estimating at least one predicted set of states of the multiple targets for a given time;
obtaining, for the given time, a set of observations acquired from at least one sensor;
calculating a plurality of associations as a function of the at least one predicted set of states and the set of observations;
generating, as a function of the plurality of associations, a respective plurality of updated sets of states of the multiple targets for the given time;
selecting, from the plurality of updated sets of states, a set of states defining a best correlation with the set of observations; and
setting, for the given time, respective states of the multiple targets in accordance with the selected set of states.

2. The method of claim 1, further comprising: displaying the selected set of states.

3. The method of claim 1, wherein the plurality of associations is a first plurality of associations, wherein the set of observations is a first set of observations, wherein estimating at least one first set of states comprises: estimating the at least one predicted set of states as a function of at least one set of a second plurality of updated sets of states of the multiple targets, wherein the at least one set of a second plurality of updated sets of states is generated as a function of a second plurality of associations, wherein the second plurality of associations are calculated as a function of estimates of states of the multiple targets and a second set of observations for a time prior to the given time.

4. A tangible computer-readable storage medium comprising program instructions, wherein the program instructions are computer executable to:
estimate at least one predicted set of states of the multiple targets for a given time;
obtain, for the given time, a set of observations acquired from at least one sensor;
calculate a plurality of associations as a function of the at least one predicted set of states and the set of observations;
generate, as a function of the plurality of associations, a respective plurality of updated sets of states of the multiple targets for the given time;
select, from the plurality of updated sets of states, a set of states defining a best correlation with the set of observations; and
set, for the given time, respective states of the multiple targets in accordance with the best set of states.

5. The tangible computer-readable storage medium of claim 4, wherein the program instructions are computer executable to: display the selected set of states.

6. The tangible computer-readable storage medium of claim 4, wherein the plurality of associations is a first plurality of associations, wherein the set of observations is a first set of observations; wherein the program instructions are computer executable to: estimate the at least one predicted set of states as a function of at least one set of a second plurality of updated sets of states of the multiple targets, wherein the at least one set of a second plurality of updated sets of states is generated as a function of a second plurality of associations, and wherein the second plurality of associations are calculated as a function of estimates of states of the multiple targets and a second set of observations for a time prior to the given time.

7. A system comprising: a processor, memory and a data correlation engine, wherein the data correlation engine is adapted to:
estimate at least one predicted set of states of the multiple targets for a given time;
obtain, for the given time, a set of observations acquired from at least one sensor;
calculate a plurality of associations as a function of the at least one predicted set of states and the set of observations;
generate, as a function of the plurality of associations, a respective plurality of updated sets of states of the multiple targets for the given time;
select, from the plurality of updated sets of states, a set of states defining a best correlation with the set of observations; and
set, for the given time, respective states of the multiple targets in accordance with the best set of states.

8. The system of claim 7, further comprising a display adapted to display the selected set of states.

9. The system of claim 7, wherein the plurality of associations is a first plurality of associations, wherein the set of observations is a first set of observations; wherein the data correlation engine is further adapted to estimate the at least one predicted set of states as a function of at least one set of a second plurality of updated sets of states of the multiple targets, wherein the at least one set of a second plurality of updated sets of states is generated as a function of a second plurality of associations, and wherein the second plurality of associations are calculated as a function of estimates of states of the multiple targets and a second set of observations for a time prior to the given time.
